(19) United States
(12) Patent Application Publication
(10) Pub. No.: US 2012/0233712 A1
(43) Pub. Date: Sep. 13, 2012

(54) Method and Device for Accessing Control Data According to Provided Permission Information

(75) Inventors: Rainer Falk, Erding (DE); Stefan Seltzsam, Ismaning (DE)

(73) Assignee: Siemens Aktiengesellschaft, Muenchen (DE)

(21) Appl. No.: 13/510,431

(22) PCT Filed: Oct. 14, 2010
(86) PCT No.: PCT/EP2010/065453

§ 371 Date: May 17, 2012

(30) Foreign Application Priority Data
Nov. 20, 2009 (DE) 10 2009 054 114.4

(51) Int. Cl. G06F 21/00; G06F 9/455

(52) U.S. Cl. 726/30

(57) ABSTRACT

A method and device for accessing control data SD according to provided permission information RI, wherein a virtual engine VM is generated according to the provided permission information RI that serves to access the control data SD. As a result, a user can access control data SD solely via the virtual engine VM, thus ensuring that the user does not receive any access permission to the control data SD that are not described in the permission information RI.

### CROSS-REFERENCE TO RELATED APPLICATIONS

This is a U.S. national stage of application No. PCT/EP2010/065453 filed 14 Oct. 2010. Priority is claimed on German Application No. 10 2009 054 114.4 filed 20 Nov. 2009, the content of which is incorporated herein by reference in its entirety.

### BACKGROUND OF THE INVENTION

1. Field of the Invention

The present invention relates to a method and a device which allow the effective enforcement of access rights to user data, and, more particularly, to a method and device for accessing control data according to provided rights information. The invention also relates to a computer program product which prompts implementation of the method and to a data memory which stores the computer program product.

2. Description of the Related Art

It frequently occurs in automation, signal processing and telecommunication application scenarios that user data is to be protected from external access. User data may, for example, be control data of several machines that interact with one another. Thus, it is possible, for example, that at a manufacturing site a multiplicity of production machines for manufacturing a product communicate with one another and also exchange data with remote production sites and/or suppliers. In this process, defined rights to the transmitted data are to be granted to individual recipients such as suppliers. Thus, it is possible that a customer of a production firm transmits component design plans, where it is necessary to ensure that the production firm will only read out, but not edit, modify or forward, the design plans concerned.

A rights management system implements the protection of access to documents independently of a storage location of the documents. A protected document can be opened and processed by an authorized user only in accordance with the user's access rights valid for the purpose, irrespective of what storage device the document has been stored on or of what computing unit the document has been sent to. An unauthorized outsider to whom no access rights have been granted cannot obtain unauthorized information with a copy of the document that has been sent electronically, for example.

In conventional methods, documents are encrypted according to at least one encryption algorithm. The publisher of a document encrypts a document before he releases it and additionally defines the rights of specific users or groups to the content of the document. The encrypted file, together with its access rights, may be transmitted to a server. It is possible that in the process the publisher of the document will generate a piece of license information, also called an issuance license, containing the rights of users and groups. A rights license may, for example, specify that a third party, for example, a configuration machine, may read out, print out and/or store certain parts of a design plan.

The license information may additionally have a symmetrical key which is used for encrypting the document. Since this key itself constitutes a secret item of information, the rights license may be encrypted with the public key of the server and the publisher may digitally sign the rights license. In conventional methods, digital signing methods for this purpose are known.

The rights license may be stored and maintained centrally on a server. The rights license may, however, also be accommodated, i.e., encoded, with the encrypted document in a file, and consequently enables only a less dynamic rights management system. In addition to the server that is a key part of the rights management system, there must also be a client which has to be installed on each accessing machine that aims to read out access-protected documents and/or configuration data. The client may in this case handle communication with the server to determine the symmetrical key and the rights of a document in hand. The client can pass on the read rights to a further read-out unit that is provided for the observance of rights. Encryption of the document may be handled by the client, which also executes any re-encryption that may be needed at a later point in time. The key can be kept secret by the client from other read-out units by an encryption technique. In conventional methods, encryption techniques and/or concealment techniques, such as code obfuscation, are used for this purpose.

For a rights management system, control programs typically have to be adapted so that the control programs can communicate with the client for encryption and decryption and appropriate rights can be enforced which are transferred from the client to the control program.

In this respect, FIG. 1 illustrates in a schematic block diagram access to access-restricted user data in accordance with a conventional method. Here, a decryption unit is integrated in a control program, which can be termed “native integration”. The basic integration of a rights management system in a control program consists in modifying the source code of a control program appropriately. This is possible in cases where the source code of a control program is available. For the developer of the control program, native integration involves a considerable outlay in terms of time. For this reason, only a small number of applications have been available to date with native rights management support. In the conventional method of native integration, it is possible, for example, to proceed as follows:

In a first method step 11 a control program X opens a document comprising, for example, user data. In a further method step 12, the user data is loaded by a machine Y. The control program X then prompts authentication in a rights client RC in method step 13. The rights client RC can now perform authentication in a rights server RS in method step 14. Access rights together with a cryptographic key for the user data can be transferred in a method step 15 from the rights server RS to the rights client RC. These rights can be transferred from the rights client RC to the control program X in a method step 16, whereupon the control program transmits a decryption request to the rights client RC in a method step 17. Since authentication is now complete, the decrypted user data can be conveyed to the control program X in a subsequent method step 18.

In an alternative conventional method, communication between the machine Y and the rights client RC with the control program X can be outsourced to a “wrapper unit”. This wrapper unit can accept the control program's operating-system calls, such as loading configuration data, and replace these with its own control commands.

Conventional methods are typically associated with a high expenditure as an appropriate infrastructure for the management and enforcement of access rights has to be provided. There is therefore a need for the secure provision of access rights to user data, even in existing infrastructures. Furthermore, there are a large number of security loopholes or possibilities for circumventing the rules in conventional rights management methods.

### SUMMARY OF THE INVENTION

It is therefore an object of the present invention to provide a method and a device which permit access to control data solely according to provided rights information.

This and other objects and advantages are achieved in accordance with the invention by a method for accessing control data according to provided rights information comprising provision of control data and of at least one piece of rights information, generation of a virtual machine according to the at least one provided piece of rights information, and access to the provided control data by means of the virtual machine.

Control data may be any type of user data and/or signals. This control data may be provided, for example, by a readout from a data memory or may be transferred from another data processing unit via a network. The provision of control data may also comprise the selection of certain control data from a multiplicity of control data. For example, a database may comprise control data, the control data describing with other metadata at least a part of the control data. It is possible for certain control data to be selected from a content management system depending on the stored metadata. The control data concerned may also be documents. A document may comprise, inter alia, a textual specification and/or design plans. Furthermore, the control data may also be configuration files of a machine, in particular a computing machine, or a manufacturing plant. The provision of control data may comprise several substeps such as calculating, measuring and/or estimating control data.

The rights information may, with regard to at least part of the control data, define access information or access rights. For example, it is possible for a certain computing unit which is identified, for example, by an IP address and/or an IP range, to receive rights solely to individual parts of the control data. The rights information describes what rights a particular stakeholder has to the provided control data. A right in this case may comprise an access right, execution right, a print right, a read-out right, a change right and/or other rights with regard to control data. If the control data defines execution commands and/or control commands, then it is possible that the rights information a prompting of the execution of these control commands will be available only under certain conditions. An example of such a condition is a time stamp. In this way, it is possible for a specified user to prompt execution of the control commands only at a specified time and/or with respect to a specified time range.

The rights information can be extracted from the control data and/or provided separately to the control data. It is also possible for the information to be included in the control data. For example, provision of at least one piece of rights information can follow by analysis of the control data. The rights information can be encoded in the control data. For example, the control data is provided in a file, the file having at least one piece of rights information. If at least part of the control data is provided in XML format, then it is possible in accordance with a predefined format to define control data at a specified point within the file and to encode rights information at a further point in the file.

A computing unit is suitable here for reading out the file and with the aid of meta-information recognizing and then reading out control data and/or rights information. It is also possible for the rights information to be provided by a first server and the control data to be provided by a second server. Rights information can therefore relate to a machine configuration, where the machine accesses the control data according to the rights information. For example, the rights information may describe a data memory that is to be used when executing the control data. A piece of rights information is, for example, that a buffer of a machine has a certain number of kilobytes.

If further units are necessary to execute the control data, then the rights information may simply specify these further units. If the control data prompts printing of information to an output medium, a printing unit can be described by the rights information. If the control data prompts printout of copies by a color copier, for example, it can be specified in the rights information whether color is actually to be used in the printout. The rights information may thus indicate that commands relating to a color copier can prompt only black-and-white printing. Furthermore, the rights information may define that a specified computing system can prompt color printing in the copier, while another computer system can prompt only black-and-white printing.

Furthermore, a virtual machine is generated according to the at least one provided piece of rights information. The generation of a virtual machine can be implemented in accordance with a replication, emulation, virtualization and/or at least a part thereof. For example, the virtual machine can be generated partly through emulation and partly through virtualization. In this process, physical hardware units of a host system, i.e., a guest system, are replicated. For example, the host system comprises a physical hardware unit which in accordance with a removable data medium acts as a reading device. A physical hardware unit, such as a CD reader, can be simulated in the virtual machine in accordance with a replication. In this process, the virtual machine provides at least part of the functionality of the physical CD reader. The virtual machine may consequently be a number of control commands provided by a physical hardware unit or a plurality of physical hardware units interacting with one another. The virtual machine generated in this way according to at least one provided piece of rights information is thus a copy of the host system according to an expanded specification.

The replication of the physical hardware unit is advantageous in particular where the physical hardware unit is in operation and the operation cannot be interrupted. If the physical hardware unit offers a service, for example, it can be replicated and, using the replicated virtual hardware unit, requirements parameters can be determined for the physical hardware unit. In this way, the service offered can be offered without interrupting the physical hardware unit. In particular, it is possible to implement the replication of hardware units in a software-based manner. To do this, operating parameter profiles can be varied systematically and reproducibly without modifying the physical computer system.

The replication can also prompt an emulation or virtualization. Here, emulation may comprise the partial provision of functionality by the virtual hardware unit, where it is possible for functionality that is not provided to be provided by a physical hardware unit. Virtualization here may comprise the provision of functionality by the virtual hardware unit. The replicated hardware unit exists virtually and is described and/or replicated, for example, by a software component and/or by a library. The physical hardware unit exists physically, i.e., materially.

Emulation may comprise the partial provision of functionality by the virtual hardware unit, where it is possible for functionality that is not provided to be provided by a physical hardware unit. For example, in the case of emulation, read access to a first data set of a hard disk can be executed by a virtual hardware unit and write access to a second data set of the hard disk by a physical hardware unit.

Virtualization may in this case describe the complete provision of functionality by the virtual hardware unit. For example, in the case of the virtualization of a physical hard disk the functionality of the physical hard disk, such as the reading and writing of data sets, is executed by a virtual hard disk. A virtual hard disk is in this case a virtual hardware unit that provides the functionality of a physical hard disk through emulation or virtualization. Operating parameters of the virtual hardware unit, such as the storage capacity, can be provided in this case using a physical hard disk.

A physical computer system is consequently replicated as a virtual computer system, where it is possible for the virtual computer system in turn to consist of multiple virtual hardware units. The rights information provided consequently describes virtual hardware units of the virtual machine, which act in accordance with a host system. It is, for example, possible for a user to operate a computing system to which a printer is connected.

If this user now receives control data comprising at least one piece of rights information, the rights information granting no printer rights, then a virtual machine is generated which replicates the user's host system. However, in this replicated host system, i.e., the virtual machine, no virtual printer is provided. Furthermore, the virtual machine may in accordance with the rights information be prohibited from accessing the physical printer of the host system. As a result, no printing is possible when executing the control data in the virtual machine.

Consequently, the control data provided is accessed using the virtual machine. The person with access authorization can thus exercise his access rights solely by this virtual machine. Access to the control data provided is thus possible solely in accordance with the provided rights information. The provided control data can thus not be executed directly on the host system, but only in a higher abstraction layer in the virtual machine.

In an embodiment of the method in accordance with the present invention, accessing the provided control data comprises reading out, writing, executing, printing and/or forwarding the control data.

This has the advantage that access to the provided control data can be restricted with regard to a plurality of operations.

In a further embodiment of the method in accordance with the present invention, the access is implemented to a part of the control data.

This has the advantage that access rights to only a part of the control data can also be defined.

In a further embodiment of the method, the control data is provided in an encrypted manner.

This has the advantage that the control data can be secured according to an encryption algorithm and furthermore can be transmitted in a secured manner.

In a further embodiment, generation of the virtual machine comprises decryption of the control data.

This has the advantage that the control data is decrypted at the receiver end and can be viewed only when processed by the virtual machine.

In a further embodiment, the rights information is stored and/or provided by means of a server.

This has the advantage that the rights information can be provided by a separate computing unit or storage unit, for example, a rights server.

In a further embodiment of the in accordance with the present invention, the provided rights information comprise a key, a usage authorization, a usage restriction, a reference to an access authorization, in particular of a computer system, and/or a time stamp.

This has the advantage that the rights information can describe access rights with fine granularity and in terms of a plurality of characteristics.

In a further embodiment of the method, the control data is available as a document, a source code, a piece of graphical information, a maintenance instruction, maintenance data, machine configuration data, design data, diagnostic data and/or a file.

This has the advantage that the control data can describe any contents or information.

In a further embodiment, the control data is provided as an XML file, a formal model, a semi-formal model, a database and/or a message.

This has the advantage that the control data can be encoded, provided and/or calculated in a plurality of ways.

In a further embodiment of the method, a policy for the virtual machine is generated depending on the rights information.

This has the advantage that previously established methods for describing the virtual machine can be reused.

In yet a further embodiment, the virtual machine is configured, operated and/or executed depending on the generated policy.

This has the advantage that the policy can be used both during operation of a virtual machine and during a time when the virtual machine is being generated.

In still a further embodiment of the method, the virtual machine is generated in a volatile memory.

This has the advantage that the virtual machine can be stored in a typically fast memory, contents of the volatile memory being deleted when the host system is switched off.

In an even further embodiment of the method, the virtual machine is deleted after accessing the control data.

This has the advantage that the virtual machine no longer continues to exist and repeated access to the control data can be prevented as a result.

It is also an object of the invention to provide a device for accessing control data according to provided rights information comprising a provision unit for providing control data and at least one piece of rights information a virtualization unit for generating a virtual machine according to the at least one provided piece of rights information, and an access unit for accessing the provided control data using the virtual machine.

Also provided are a computer program product which prompts the implementation of a described method and a data memory which stores provides the computer program product.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantageous designs of the invention are the subject matter of the subclaims and of the exemplary embodiments described below. The invention will be explained in detail below with the aid of exemplary implementations and with reference to the accompanying figures, in which:

FIG. 1 shows a message exchange diagram of a conventional rights management method;

FIG. 2 shows a schematic block diagram of a system architecture as may be used in a method for accessing control data in accordance with an embodiment of the present invention;

FIG. 3 shows a schematic block diagram of a device for accessing control data in accordance with an embodiment of the present invention;

FIG. 4 shows a schematic block diagram of a device for accessing control data in accordance with a further embodiment of the present invention;

FIG. 5 shows a flow chart of a method for accessing control data in accordance with an embodiment of the present invention;

FIG. 6 shows a flow chart of a method for accessing control data in accordance with an alternative embodiment of the present invention;

FIG. 7 shows a schematic block diagram of a device for accessing control data in accordance with an embodiment of the present invention; and

FIG. 8 shows a detailed schematic block diagram of a device for accessing control data in accordance with an embodiment of the present invention.

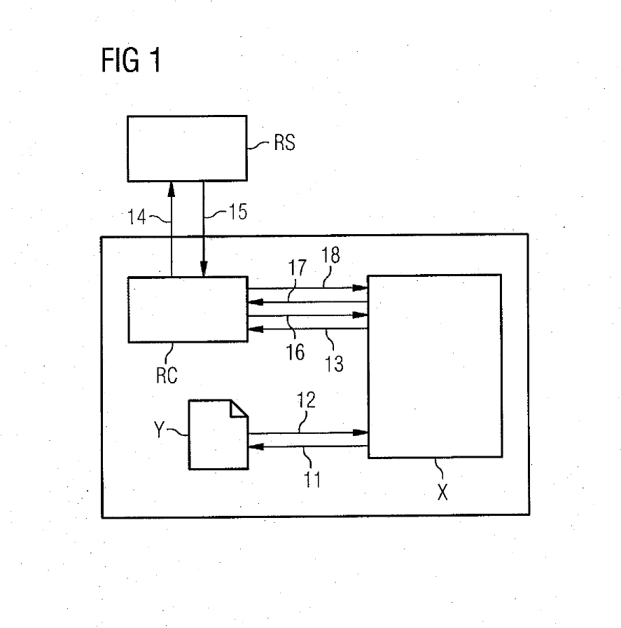

### DETAILED DESCRIPTION OF THE PREFERRED EMBODIMENTS

In the figures, identical and functionally identical elements are labeled with the same reference characters, unless indicated otherwise.

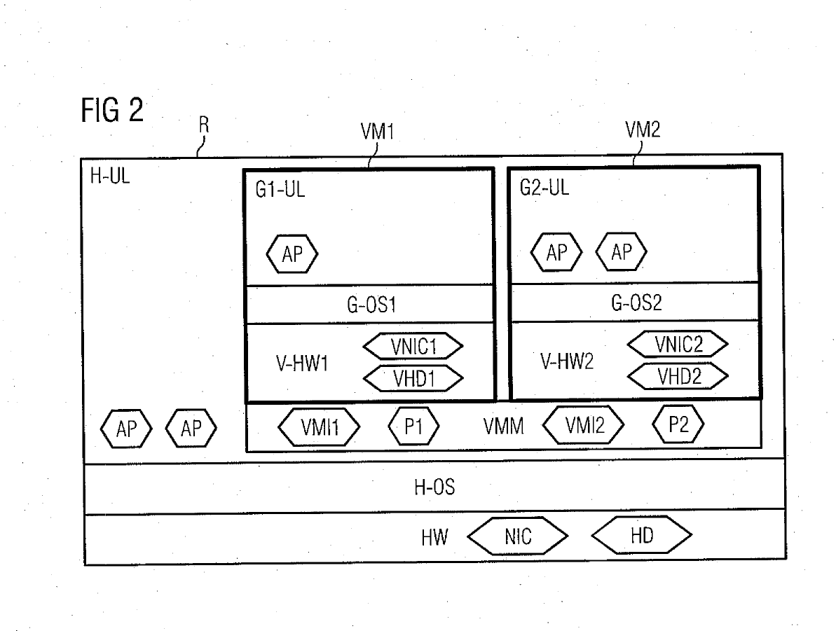

FIG. 2 shows a computer system R which in an embodiment of a method for accessing control data in accordance with an embodiment of the present invention can be used as a host system for a virtualization. The host system has a multiplicity of hardware components HW, such as the network adapter NIC and the hard disk HD. On the host computer R, a host operating system H-OS is used. Here, a user mode H-UL, also termed a user land, can be provided in which application programs AP are executed. In the present FIG. 2, a plurality of execution programs AP are used which are each designated AP. Consequently, the application programs AP may in each case be different application programs AP.

Also executed on the host computer R is a special application, i.e., the virtual machine monitor VMM, which provides a virtual execution environment. Two virtual machines VM1 and VM2 are also executed. The virtual machine monitor VMM provides in each case a piece of virtual hardware, for example, V-HW1 or V-HW2, with a virtual network adapter, for example, VNIC1 or VNIC2, and a virtual hard disk, for example, VHD1 or VHD2. In the virtual machine VM, a guest operating system G-OS1 or G-OS2 and in the user mode, for example, user mode G1-UL or G2-UL, of the respective virtual machine VM a plurality of application programs AP are operated. For a virtual execution environment, an image, for example, VMI1 or VMI2, is available, which represents a copy of the virtual execution environment.

The virtual machine monitor also manages two policies, P1 and P2, which each define the possibility of a virtual execution environment. The policies P1 and P2 consequently describe a configuration of a virtual machine. Accessing the virtual execution environment is possible only where this is permitted by the respective policy.

In addition, the computer R is connected via the network adapter NIC to a network such that a rights server can be addressed.

In an embodiment the method for accessing control data according to the present invention, the following method steps can be executed on the computer system R:
1. Inputting of an instruction for opening an application program AP on the computing system and specification of a file as the call parameter.
2. Checking, for example, through the computer operating system H-OS, whether the file is rights-protected. If this is not the case, then the application program is started from here by specifying the file as the call parameter on the computer and is executed directly, for example, in user mode H-UL. A check can also be made of the application program AP with regard to possible rights protection. If the application AP allows rights protection, then the application program AP is started by specifying the file as the call parameter on the computing system R and executed directly in the user mode A-UL.
3. If a possible rights protection is not provided, then in a further method step the access rights of the calling user who wishes to access the control data can be determined. This can be done, for example, by a query to a rights server.
4. A translation of the determined authorizations of the calling user into a corresponding virtual machine configuration VMC can then be implemented.
5. In a further method step, a decryption and optionally a conversion of the format of the file can be performed.
6. In a subsequent method step, a virtual machine image VMI which furthermore comprises the file and the called application program AP together with the associated policy can be generated.
7. In a further method step, the generated virtual machine image VMI can be started.
8. In a subsequent method step, a launch of the application program AP in the virtual execution environment, i.e., in the virtual machine, can be implemented.
9. In a further method step, the control data of the file of the virtual execution environment is accessed.

The method steps described can be executed iteratively and/or in a different order.

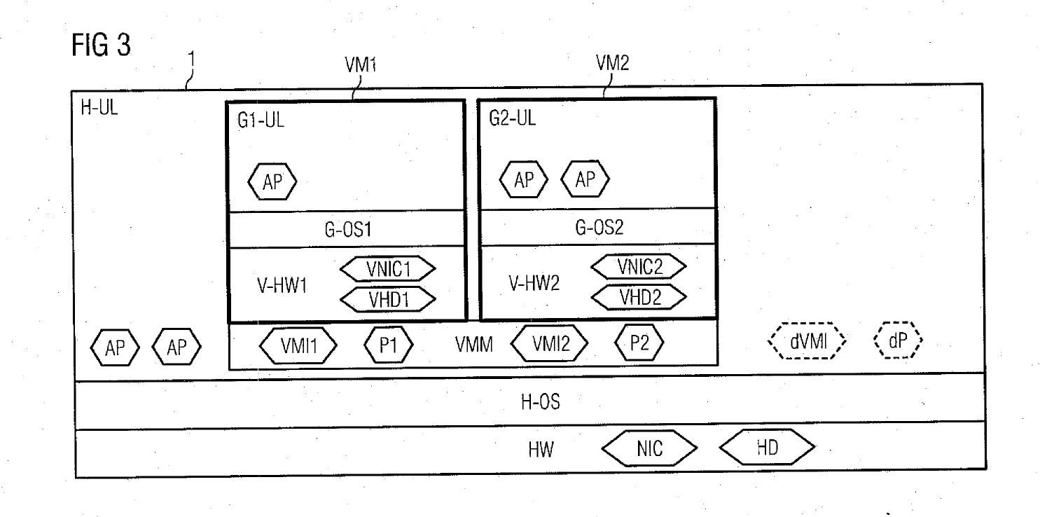

FIG. 3 shows a schematic block diagram of a device 1 for accessing control data according to an embodiment of the present invention. In the present embodiment, a dynamic virtual machine image dVMI is generated and an associated policy dP is also generated. Consequently, a virtual machine dVMI is available which is generated in accordance with provided rights information, i.e., the policy dP.

It is, however, also possible for only an image of the virtual machine to be generated provisionally. The image of the virtual machine dVMI describes the virtual machine by which the provided control data, as well as corresponding information that is necessary for operating the virtual machine, are accessed. For example, the dynamic virtual machine image dVMI can also store the control data. In one embodiment, the dynamic virtual machine image dVMI is available as a file which is stored in a storage system of the host computer R.

In a further embodiment, the virtual machine dVM is generated depending on the dynamic virtual machine image dVMI and the policy dP.

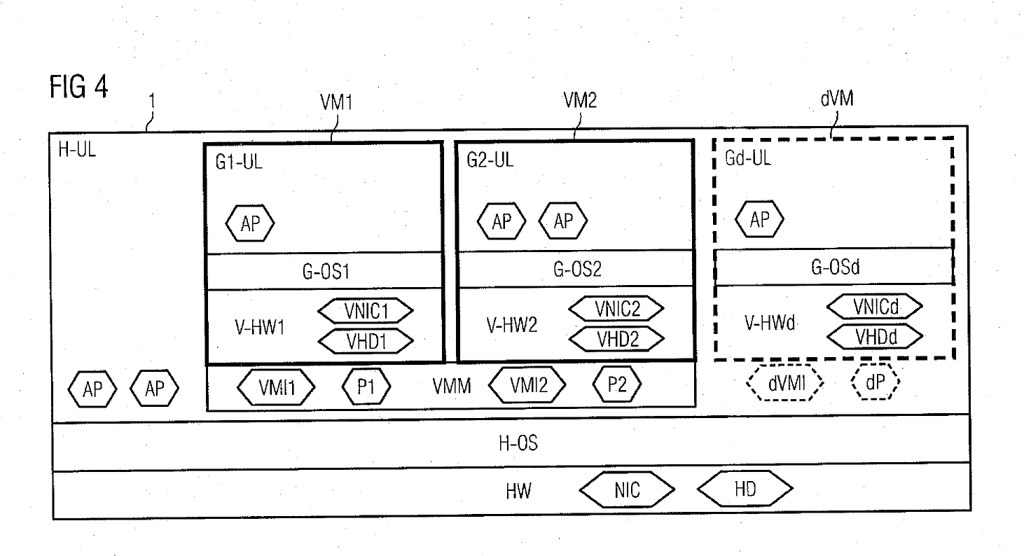

Such a virtual machine dVM is represented in FIG. 4 in accordance with an embodiment of the method for accessing control data according to the present invention. The generated virtual machine dVM has a user mode Gd-UL which makes it possible to execute and/or access the provided control data using the virtual machine dVM. The program to be executed AP can consequently be executed in the virtual machine dVM, access rights being restricted, however, according to the policy dP. In this way, the system can be executed on the physical computer a virtual computer system dVM, which in turn prompts an execution of the application program AP.

FIG. 5 shows an activity diagram of the method for accessing control data in accordance with provided rights information according to an embodiment of the present invention. The method for accessing control data comprises provision 100 of control data and at least one piece of rights information, generation 101 of a virtual machine according to the at least one provided piece of rights information, and access 102 of the provided control data using the virtual machine.

The described method steps can be executed iteratively and/or in a different order.

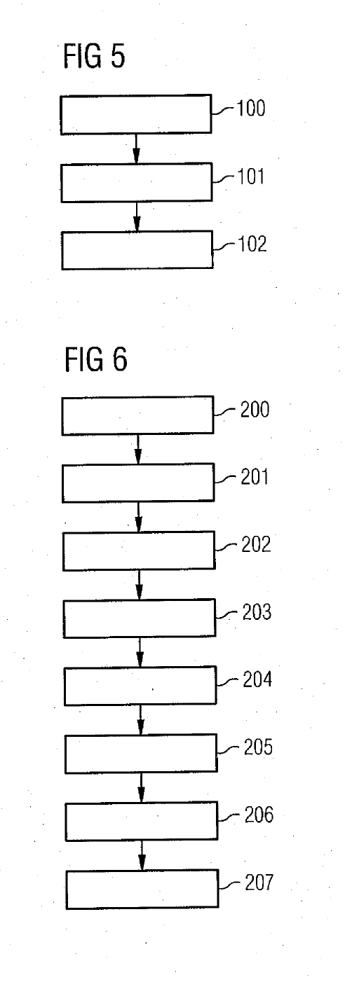

FIG. 6 shows a detailed activity diagram of a method for accessing control data in accordance with an embodiment of the present invention.

To this end, in a first method step 200 control data is selected comprising a plurality of control data. The control data is comprised, for example, in a document, where the document is selected from a plurality of documents. The selection of the control data can be made by a selection unit, for example, a document server or file server. Once the control data has been selected, then in a further method step 201, provision of this same control data occurs. Control data can be provided, for example, by transmitting the control data from a server to a client. A provision of control data may, however, also comprise any reading in of the data, for example, from a removable data medium.

Depending on the control data provided in method step 201 and the rights information provided in method step 202, in a subsequent method step 203 a policy is generated. A policy can be a configuration file granting defined access rights. Access rights can be granted by providing a corresponding functionality. If, for example, print rights are granted to part of the control data, then the policy describes that a virtual printer must be available in the virtual machine. Consequently, the policy describes virtual hardware units together with their operating parameters. An operating parameter may, for example, describe the size of a memory, the speed of a processor, a bandwidth of a network connection and/or colors of a printer.

In a method step 204, a virtual machine image is generated. The virtual machine image may, for example, be stored as an image file on the host computer. The image describes the control data, the rights information, the generated policy and/or the virtual machine. The virtual machine comprises in this case hardware components that interact with one another and in this way provide a functionality according to the generated policy. Operation of the virtual machine, i.e., accessing of the control data in accordance with the rights information, can now be performed in a method step 205. Accessing may comprise the reading out of the control data, for example, the reading out of a sequence of control commands. Accessing may also be a provision of the control data to a user, for example, by an output unit.

Once the control data has been read out, then in a further optional method step 206, the control data may be executed. Execution of the control data is, for example, the operation of a machine according to the read-out control data. In a further optional method step 207, the virtual machine is deleted. This prevents the control data from being accessed and re-executed according to the provided rights information.

The previously described method steps can be executed iteratively and/or in a different order.

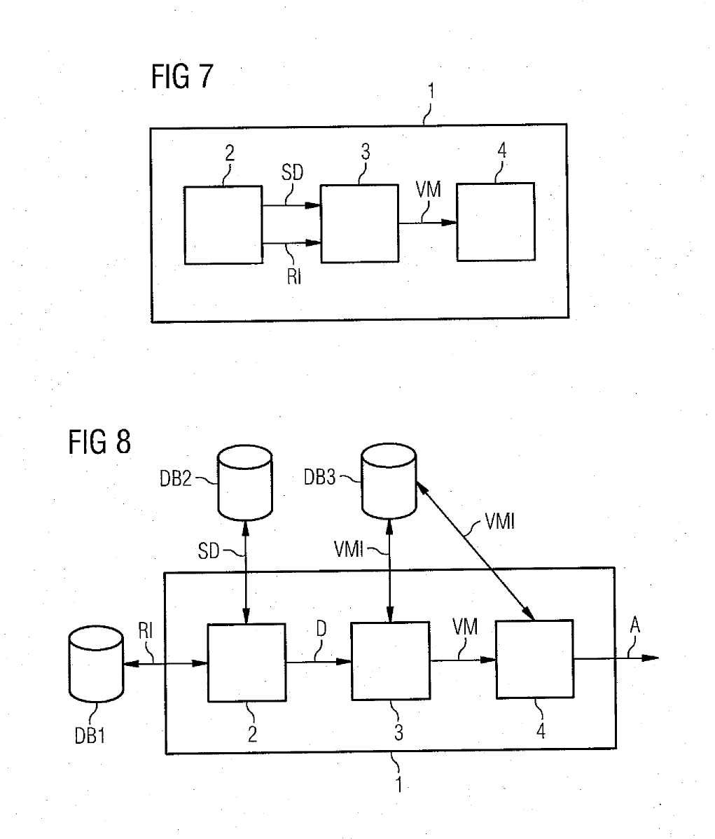

FIG. 7 shows a block diagram of a device 1 for accessing control data SD according to provided rights information RI. The device 1 comprises the following units, a provision device 2 for providing control data SD and at least one piece of rights information RI, a virtualization device 3 for generating a virtual machine VM according to the at least one provided piece of rights information RI, and an access device 4 for accessing the provided control data SD using the virtual machine VM.

FIG. 8 shows a further embodiment of a device 1 for accessing control data SD and differs from the device 1 according to FIG. 7 as described subsequently.

In the present embodiment, control data SD and at least one piece of rights information RI are provided by at least one readout from data memories. The data memories DB1 and DB2 are used for this purpose. In an alternative embodiment, the control data SD and the rights information RI can also be read out from a single data memory.

The provided control data SD and the provided rights information RI are transmitted in a file D to the virtualization device 3. The virtualization device 3 is suitable for providing an image of a virtual machine VMI and for providing a virtual machine VM of the access device 4. Provision of the virtual machine can also be effected, for example, through direct access of the access device 4 to the virtual machine and/or the virtual machine can be operated by means of a virtual machine image VMI. For this purpose, the virtual machine image VMI can be stored and provided by a further data memory DB3. The access device 4 is suitable for generating an output A depending on an accessing of the provided control data SD by the virtual machine VM.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A method for accessing control data according to provided rights information, comprising:
generating a configuration of a virtual machine according to at least one piece of rights information which describes what rights to the control data exist;
starting the virtual machine on a computer system;
executing an application program on the virtual machine; and
accessing the control data using the application program executed on the virtual machine.

18. The method as claimed in claim 17, wherein the step of accessing the control data comprises at least one of reading out, writing, executing, printing and forwarding the control data.

19. The method as claimed in claim 17, wherein the step of accessing comprises accessing a part of the control data.

20. The method as claimed in claim 17, wherein the step of generating the configuration of the virtual machine comprises encrypting the control data.

21. The method as claimed in claim 17, wherein the at least one piece of rights information is at least one of stored and provided by a server.

22. The method as claimed in claim 17, wherein the at least one piece of rights information includes at least one of a key, a usage authorization, a usage restriction, a reference to an access authorization, in particular of a computer system and a time stamp.

23. The method as claimed in claim 17, wherein the control data comprises one of a document, a source code, a piece of graphic information, a maintenance instruction, maintenance data, machine configuration data, design data, diagnostic data and a file.

24. The method as claimed in claim 17, wherein the control data is comprises at least one of xml data, a formal model, a semi-formal model, a database and a message.

25. The method as claimed in claim 17, wherein the virtual machine is generated in a volatile memory.

26. The method as claimed in claim 17, furthermore comprising:
deleting the virtual machine after accessing the control data.

27. A device for accessing control data according to provided rights information, comprising:
a virtualization device configured to generate a configuration of a virtual machine according to at least one piece of the provided rights information describing what rights to the control data exist;
a computer system on which the virtual machine is executed and on which an application program on the virtual machine is executed; and
an access device which accesses the control data using the application program executed on the virtual machine on the computer system.

28. A process in which a computer executes instructions set forth in a computer program executing on a processor which, when used on the computer, causes the processor to access control data according to provided rights information, the computer program comprising:
program code for generating a configuration of a virtual machine according to at least one piece of rights information which describes what rights to the control data exist;
program code for starting the virtual machine on a computer system;
program code for executing an application program on the virtual machine; and
program code for accessing the control data using the application program executed on the virtual machine

29. A non-transitory computer-readable data memory encoded with a computer program executed by a computer that causes access of control data according to provided rights information, the computer program comprising:
program code for generating a configuration of a virtual machine according to at least one piece of rights information which describes what rights to the control data exist;
program code for starting the virtual machine on a computer system;
program code for executing an application program on the virtual machine; and
program code for accessing the control data using the application program executed on the virtual machine.
